(19) United States
(12) Patent Application Publication
(10) Pub. No.: US 2010/0153678 A1
(43) Pub. Date: Jun. 17, 2010

(54) MEMORY MANAGEMENT APPARATUS AND METHOD

(75) Inventors: Dongwook KANG, Daejeon-city (KR); Kwangyong Lee, Daejeon-city (KR); Chaedeok Lim, Daejeon-city (KR); Seungmin Park, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-city (KR)

(21) Appl. No.: 12/638,286

(22) Filed: Dec. 15, 2009

(30) Foreign Application Priority Data
Dec. 16, 2008 (KR) 10-2008-0127952

(51) Int. Cl. G06F 12/02; G06F 12/00

(52) U.S. Cl. 711/170; 711/E12.001; 711/E12.002

(57) ABSTRACT

Disclosed is a memory management apparatus and method. The memory management apparatus includes a memory, an asymmetrical multi-core processor in which a core having a memory management unit and a core not having a memory management unit exist together, and a memory allocation processing unit. The memory allocation processing unit collects memory fragments dispersed in the memory into one consecutive area in response to the memory allocation request from the core not having the memory management unit and then allocates the one collected consecutive area to the corresponding cores. The one consecutive area is formed by moving the memory areas that are being used by the core having the memory management unit.

### RELATED APPLICATIONS

The present application claims priority to Korean Patent Application Serial Number 10-2008-00127952, filed on Dec. 16, 2008, the entirety of which is hereby incorporated by reference.

### BACKGROUND OF THE INVENTION

1. Field of the Invention

The present invention relates to a memory management apparatus and method for solving a memory fragmentation problem, and in particular, to a memory management apparatus and method for solving a memory fragmentation problem in an asymmetrical multi-core system.

2. Description of the Related Art

A single core process having one core removes a fragmentation phenomenon that occurs during the use of a memory by a virtual memory technique using a memory management unit. A multi-core process developed to overcome the limitation of the single core processor also uses the memory management unit for efficiently using the memory. If the same types of cores are used, it is referred to as a symmetrical multi-core processor and if different types of cores are used, it is referred to as an asymmetrical multi-core processor.

In the case of the symmetrical multi-core processor, each core generally includes the memory management unit and uses the memory using the virtual memory technique. On the contrary, in the asymmetrical multi-core processor, only some cores have the memory management units.

Generally, the multi-core processor is configured such that a plurality of cores share one memory, wherein an area which each core uses is fixed statically. Further, when there is a need to exchange data between the cores, some areas of the memory are statically allocated to achieve the data exchange. Therefore, when one area does not have sufficient memory, there is a problem in that other usable areas cannot be used.

This problem can be mitigated by the memory sharing area, but in the asymmetrical multi-core processor, the core not having the memory management unit cannot use the virtual memory technique. In other words, the cores not having the memory management unit has a limitation in that it should be allocated with physically consecutive areas, which causes the fragmentation phenomenon of the shared memory area that hinders the efficient use of the memory.

### SUMMARY OF THE INVENTION

The present invention proposes to solve the above problems. It is an object of the present invention to solve a memory fragmentation problem caused by cores not having a memory management unit and to enable a plurality of cores to more efficiently share a memory, in a system with an asymmetrical multi-core processor.

Other objects and advantages of the present invention can be appreciated by the following description and will be clearly described by exemplary embodiments of the present invention. Further, it will be easily known that the objects and advantages of the present invention can be implemented by means and a combination thereof shown in the appended claims.

In order to achieve the above objects, there is provided a memory management apparatus according to the present invention, including: a memory; a processor including a first core to which a consecutive area of the memory should be allocated; and a memory allocation processing unit that allocates the consecutive area of the memory in response to a memory allocation request from the first core, wherein the memory allocation processing unit forms one consecutive memory area by collecting memory fragments dispersed in the memory and then allocates the consecutive memory area to the first core, when memory fragments larger than a size of the memory requested by the first core do not exist in the memory.

The processor may further include a second core to which the consecutive area of the memory is not necessarily allocated and the memory fragments dispersed in the memory may be allocated as they are.

Further, the first core is a core not having the memory management unit and the second core is a core having the memory management unit.

Also, the memory allocation processing unit may form the consecutive memory area by moving the memory area that is being used by the second core.

Preferably, the memory allocation processing unit firstly allocates a memory fragment having the smallest size out of memory fragments dispersed in the memory in response to a memory allocation request from the second core.

Meanwhile, the memory area requested for allocation by the first core and the second core is an area shared by the first core and the second core.

Moreover, in order to achieve the above objects, there is provided a memory management apparatus according to the present invention, including: a memory; an asymmetrical multi-core processor that includes a core having a memory management unit and a core not having the memory management unit; and, in response to the memory allocation request from the core, a memory allocation processing unit that allocates a specific area of the memory to the corresponding core wherein the memory allocation processing unit forms one consecutive memory area by collecting memory fragments dispersed in the memory and then allocates the consecutive memory area to the core not having the memory management unit, when memory fragments larger than a size of the memory requested for allocation from the core not having the memory management unit do not exist in the memory.

In addition, in order to achieve the above object, there is provided a memory management method according to the present invention, including: receiving a memory allocation request from a first core in the processor including a first core to which a consecutive area of a memory should be allocated; determining whether a memory fragment larger than a size of the memory requested for allocation from the first core exists in the memory or not; if it is determined that such a memory fragment does not exist in the memory, forming one consecutive memory area by collecting memory fragments dispersed in the memory; and allocating the consecutive memory area to the first core.

The processor further includes a second core to which the consecutive area of the memory is not necessarily allocated. The memory management method may further include allocating memory fragments to the second core in a state where the memory fragments are dispersed in the memory in response to a memory allocation request from the second core.

In addition, the memory management method of the present invention may further include other characteristics of the memory management apparatus according to the present invention.

With the present invention, in the system with the asymmetrical multi-core processor, the memory fragmentation problem that occurs due to the core not having the memory management unit can be solved and the memory can more efficiently be shared by the plurality of cores.

### BRIEF DESCRIPTION OF THE DRAWINGS

FIG. 1 is a diagram showing a configuration of a memory management unit according to an embodiment of the present invention;

FIG. 2 is a flow chart of a memory management method according to an embodiment of the present invention; and

FIG. 3 is a diagram showing a movement process of a memory area depending on the memory management method according to the embodiment of the present invention.

### DETAILED DESCRIPTION OF THE PREFERRED EMBODIMENTS

Hereinafter, exemplary embodiments of the present invention will be described with reference to the accompanying drawings.

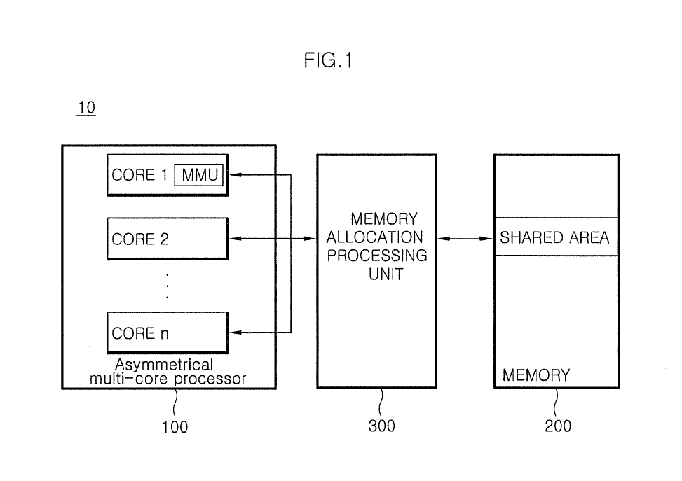

FIG. 1 shows a memory management apparatus 10 that includes an asymmetrical multi-core processor 100, a memory 200, and a memory allocation processing unit 300. The asymmetrical multi-core processor 100 has n (n is natural number) cores. Assume that core 1 has a memory management unit (MMU) and core 2 does not have the memory management unit. Further, each core can access the memory and share information with other cores through a sharing area of the memory 200.

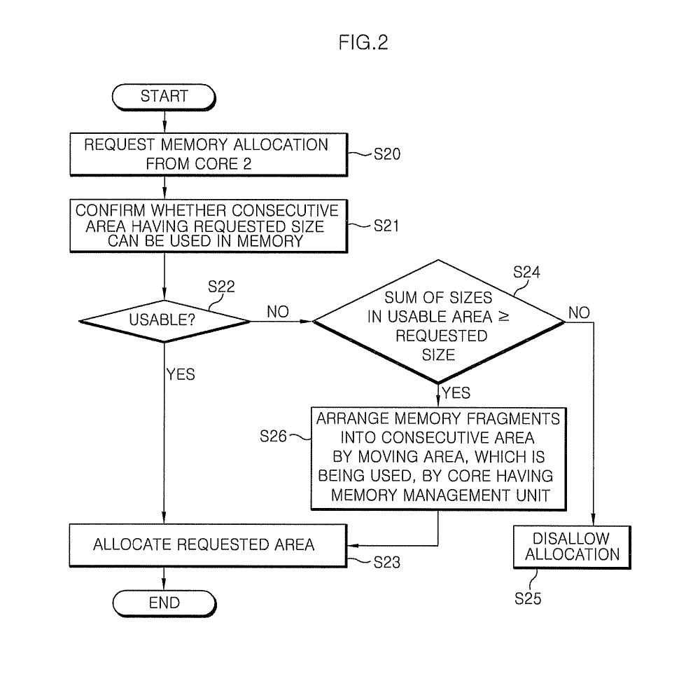

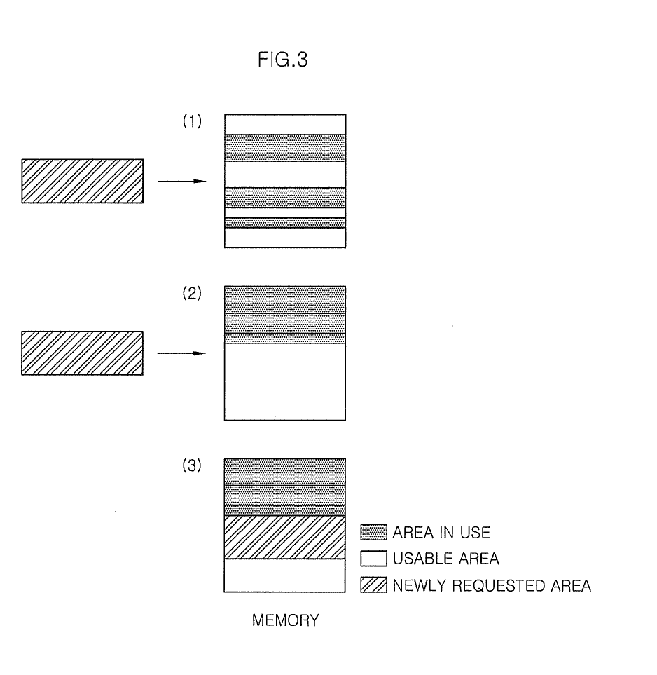

The memory allocation processing unit 300 allocates the memory to the cores depending on the memory management method (FIG. 2) according to the exemplary embodiments of the present invention. The memory allocation processing unit 300 is a functional unit implemented by a computer software (computer program), not by a separate hardware configuration. FIG. 2 shows a process of processing the memory allocation request from core 2 not having the memory management unit. FIG. 3 shows a process of arranging the fragmentations of the memory into a consecutive area.

If core 2 requests the memory allocation for the shared area of the memory (S20), the memory allocation processing unit 300 confirms whether the consecutive area having a requested size can be used in the memory (S21). If so (S22), the memory allocation processing unit 300 allocates the consecutive area having the requested size to core 2 and thus, the routine ends.

If not (S22), the memory allocation processing unit 300 determines whether the sum of sizes in the usable area is larger than the requested size (S24) ((1) of FIG. 3). If not (S24), the allocation is impossible (S25) and thus, the routine ends.

If so (S24), the memory fragments in the shared area are collected by moving the areas used by the virtual memory technique, that is, the areas used by the cores having the memory management unit, such that they are reconfigured of the consecutive areas (S26) ((2) of FIG. 3). Therefore, the memory allocation processing unit 300 can allocate the consecutive area of the memory to core 2 (S26) ((3) of FIG. 3).

At this time, the memory allocation processing unit 300 updates page table information managed in the memory management unit, etc., based on a new position in the moved memory areas. Therefore, the cores using the moved memory areas can access a correct position of the memory.

Meanwhile, when the memory allocation is requested from the core (for example, core 1) having the memory management unit, the memory allocation processing unit 300 allocates the fragment (s) of the memory to the corresponding core according to the requested size. Since it is not necessary to allocate the consecutive memory area in the case of the core having the memory management unit, the movement of the memory area as shown in FIGS. 2 and 3 is not needed.

At this time, for the core having the memory management unit, it is preferable to allocate the memory fragments having the smallest size in the usable area. This is to allocate the consecutive memory area having a possible large size to the core not having the memory management unit. As a result, the movement of the memory area as in step S26 of FIG. 2 can be minimized.

The memory management method of the present invention can be executed by a computer program recorded in a recording medium readable with a computer.

What is claimed is:

1. A memory management apparatus, comprising:
a memory;
a processor comprising a first core to which a consecutive area of the memory should be allocated; and
a memory allocation processing unit that allocates the consecutive area of the memory in response to a memory allocation request from the first core,
wherein the memory allocation processing unit forms one consecutive memory area by collecting memory fragments dispersed in the memory and then allocates the consecutive memory area to the first core, when memory fragments larger than a size of the memory requested by the first core do not exist in the memory.

2. The memory management apparatus according to claim 1, wherein the processor further comprises a second core to which the consecutive area of the memory is not necessarily allocated and the memory fragments dispersed in the memory may be allocated as they are.

3. The memory management apparatus according to claim 2, wherein the memory allocation processing unit forms the consecutive memory area by moving the memory area that is being used by the second core.

4. The memory management apparatus according to claim 2, wherein the memory allocation processing unit firstly allocates a memory fragment having the smallest size out of memory fragments dispersed in the memory in response to a memory allocation request from the second core.

5. The memory management apparatus according to claim 1, wherein the memory area requested for allocation by the first core and the second core is an area shared by the first core and the second core.

6. The memory management apparatus according to claim 1, wherein the first core does not have a memory management unit.

7. The memory management apparatus according to claim 2, wherein the second core has a memory management unit.

8. A memory management apparatus, comprising:
a memory;
an asymmetrical multi-core processor that includes a core having a memory management unit and a core not having the memory management unit; and
a memory allocation processing unit that, in response to the memory allocation request from the core, allocates a specific area of the memory to the corresponding core,
wherein the memory allocation processing unit forms one consecutive memory area by collecting memory fragments dispersed in the memory and then allocates the consecutive memory area to the core not having the memory management unit, when memory fragments larger than a size of the memory requested for allocation from the core not having the memory management unit do not exist in the memory.

9. The memory management apparatus according to claim 8, wherein the memory allocation processing unit forms the consecutive memory area by moving the memory areas that are being used by the core having the memory management unit.

10. The memory management apparatus according to claim 8, wherein the memory allocation processing unit first allocates a memory fragment having the smallest size out of the memory fragments dispersed in the memory in response to a memory allocation request from the core having the memory management unit.

11. The memory management apparatus according to claim 8, wherein the specific area of the memory allocated to the core is a memory area that is shared by the cores included in the asymmetrical multi-core processor.

12. A memory management method, comprising:
receiving a memory allocation request from a first core in a processor including the first core to which a consecutive area of a memory should be allocated;
determining whether a memory fragment larger than a size of the memory requested for allocation from the first core exists in the memory or not;
if it is determined that such a memory fragment does not exist in the memory, forming one consecutive memory area by collecting memory fragments dispersed in the memory; and
allocating the consecutive memory area to the first core.

13. The memory management method according to claim 12, wherein the processor further comprises a second core to which the consecutive area of the memory is not necessarily allocated, and the memory management method may further include allocating memory fragments to the second core in a state where the memory fragments are dispersed in the memory in response to the memory allocation request from the second core.

14. The memory management method according to claim 13, wherein the forming forms the consecutive memory area by moving the memory area that is being used by the second core.

15. The memory management method according to claim 13, wherein the allocating the memory fragments to the second core firstly allocates a memory fragment having the smallest size out of the memory fragments dispersed in the memory.

16. The memory management method according to claim 13, wherein the memory area requested for allocation by the first core and the second core is an area shared by the first core and the second core.

17. The memory management method according to claim 12, wherein the first core does not have the memory management unit.

18. The memory management method according to claim 13, wherein the second core has the memory management unit.
